(19) United States
(12) Patent Application Publication
(10) Pub. No.: US 2009/0189986 A1
(43) Pub. Date: Jul. 30, 2009

(54) BIOMIMETIC MODELLING SYSTEMS FOR REPRODUCING SPREADING PHENOMENA OF COSMETIC AND PHARMACEUTICAL FORMULATIONS ON HUMAN SKIN

(75) Inventors: Ralph Scheuermann, Essen (DE); Christian Frech, Mannheim (DE); Jurgen Meyer, Essen (DE)

Correspondence Address: SCULLY SCOTT MURPHY & PRESSER, PC, 400 GARDEN CITY PLAZA, SUITE 300, GARDEN CITY, NY, 11530, US

(73) Assignee: EVONIK GOLDSCHMIDT GMBH, Essen (DE)

(21) Appl. No.: 12/357,050

(22) Filed: Jan. 21, 2009

(30) Foreign Application Priority Data
Jan. 25, 2008 (DE) 102008006086.0

(51) Int. Cl. H04N 5/225; C08L 89/00

(52) U.S. Cl. 348/207.1; 525/54.1

(57) ABSTRACT

The invention relates to a skin substitute for investigating the behavior of cosmetic and pharmaceutical compositions to be applied topically, where the skin substitute is a three-dimensionally crosslinked polyacrylamide matrix and water and at least one polypeptide is bonded in

### FIELD OF THE INVENTION

The invention relates to a device for the simulation of the human skin surface in order to reproduce and investigate physical phenomena such as, for example, the spreading behavior of oils on this device.

### BACKGROUND OF THE INVENTION

For cosmetic and pharmaceutical formulation to be applied topically, the behavior upon application to the skin is of decisive importance. One parameter, which is often measured, is the spreading rate of the substance to be tested.

In order to obtain representative measurement data, so-called panel tests on human subjects continue to be carried out in practice. These tests are expensive, laborious and, moreover, on account of the high variance of individual parameters such as, for example, skin moisture, and the nature of the surface, a very large number of subjects is required in order to obtain reproducible data material. The need for a new modelling system with which the results of the panel test in the laboratory can be illustrated in a cost-effective and reproducible way, thus a mimetic for human skin, is therefore great.

On account of the innumerous high requirements placed thereon, skin is a tissue of complex structure consisting of several layers of various cell types. The cell walls in turn are permeated with complex mixtures of highly different chemical substances such as, for example, ceramides, phospholipids and fatty acids. This fact hinders the selection of suitable substances for recreating the human skin surface.

The prior art describes models of acrylatic polymers which are supposedly suitable for testing numerous properties of cosmetic products, thus, for example, determining the diffusion of toxic substances into the matrix, ascertaining sun protection factors, investigating the distribution properties and behavior of solid makeup particles (WO9721097).

U.S. Pat. No. 4,877,454 describes a skin model for testing the adhesive behavior of plasters which is based on the use of gelatin-polymer matrices. Gelatins are not suitable for determining spreading rates since the results are not reproducible on account of the inhomogeneity of the gelatin polymerization. The polymerization process leads to nonuniform pore sizes, both within a matrix and also compared between two independent polymerization processes. Added to this is the batch variance which, as is the case for all biological materials such as gelatin, further impairs the reproducibility. Moreover, some substances additionally spread very irregularly on gelatin plates (formation of spreading fingers).

The same disadvantages arise with the model described in U.S. Pat. No. 5,015,431, which was also developed for investigating adhesives and is based on polymerizable, soluble proteins.

The prior art gives no information as to how the rate series, found in the panel test, of the average spreading rates of various substances can be reproducibly recreated in an in vitro model.

### SUMMARY OF THE INVENTION

The present invention provides an alternative material with which the spreading behavior of substances on the skin can be reproducibly simulated and/or predicted, without the formation of spreading fingers. Furthermore, the present invention provides a material whose surface nature can be variably configured in a way such that the rate series, found in a panel test, of the average spreading rates of different substances can be reproducibly recreated in an in vitro model.

Specifically, the present invention provides a device in which a skin substitute for mimicking the physical surface properties of human skin is used for investigating the behavior of topically applied cosmetic and/or pharmaceutical products. The skin substitute employed in the inventive device is a three-dimensionally crosslinked polyacrylamide matrix, which superbly recreates the surface nature with regard to the spreading behavior of human skin when water and at least one polypeptide is bonded in the matrix.

The present invention also provides a process for adapting the inventive device described above to a series of compositions to be investigated. The present invention also provides a method for simulating or predicting the spreading behavior or cosmetic and/or pharmaceutical formulations on human skin.

### BRIEF DESCRIPTION OF THE DRAWINGS

FIG. 1 is an exemplary graph of lg area vs. lg time in which a mathematical kinetic model was employed to determine the spreading behavior of a drop on a surface.

FIG. 2 is the non logarithmic graph of the corresponding values of FIG. 1.

FIG. 3 shows the area of a drop size after 5 minutes of spreading on human skin for different substances with and without additive.

FIG. 4 is a graph of area vs. time of spreading properties on CleanGel IEF rehydrated with demineralized water for different substances with and without additive.

FIG. 5 is a graph of area vs. time of spreading properties on CleanGel IEF rehydrated with a lipid mixture for different substances without additive.

FIG. 6 is a graph of area vs. time of spreading properties on CleanGel IEF rehydrated with a lipid mixture for different substances with and without additive.

FIG. 7 shows the area of a drop size after 5 minutes of spreading on human skin for different substances without additive.

FIG. 8 is a graph of area vs. time of spreading properties on CleanGel IEF rehydrated with BSA (1 mg/ml) in acetate buffer for different substances without additive.

FIG. 9 is a graph of area vs. time of spreading properties on CleanGel IEF rehydrated with BSA (2 mg/ml) in acetate buffer for different substances without additive.

FIG. 10 is a graph of area vs. time of spreading properties on CleanGel IEF rehydrated with different concentrations of BSA in acetate buffer for emollient B without additive.

FIG. 11 is a graph of area vs. time of spreading properties on CleanGel IEF rehydrated with acetate buffer at pH 5.5 for different substances with and without additive.

FIG. 12 shows the area of a drop size after 5 minutes of spreading on human skin for different substances with additive.

FIG. 13 is a graph of area vs. time of spreading properties on CleanGel IEF rehydrated with BSA (1 mg/ml) in acetate buffer for different substances with additive.

FIG. 14 is a graph of area vs. time of spreading properties on CleanGel IEF rehydrated with BSA (2 mg/ml) in acetate buffer for different substances with additive.

FIG. 15 is a graph of area vs. time of spreading properties on CleanGel IEF rehydrated with alpha-lactalbumin in acetate buffer for different substances with additive.

FIG. 16 is a graph of area vs. time of spreading properties on CleanGel IEF rehydrated with alpha-lactalbumin in acetate buffer for different substances without additive.

FIG. 17 is a graph of area vs. time of spreading properties on CleanGel IEF rehydrated with beta-lactoglobulin in acetate buffer for different substances without additive.

FIG. 18 is a graph of area vs. time of spreading properties on CleanGel IEF rehydrated with beta-lactoglobulin in acetate buffer for different substances with additive.

FIG. 19 is a graph of area vs. time of spreading properties on CleanGel IEF rehydrated with beta-lactoglobulin in acetate buffer for different substances with and without additive.

### DETAILED DESCRIPTION OF THE INVENTION

As stated above, the present invention provides a device including a skin substitute for investigating the behavior of cosmetic and/or pharmaceutical compositions to be applied topically. The skin substitute employed in the inventive device is a three-dimensionally crosslinked polyacrylamide matrix in which water and at least one polypeptide are bonded in the matrix.

By employing the inventive device described above it is now possible to ascertain, in a rapid and cost-saving manner, the optimum composition of a topical formulation in several e.g., active ingredient dilution or emollient concentration series. Such a qualitatively comparative in vitro simulation of panel test results has hitherto only been possible with difficulty, if at all, using current devices according to the prior art due to the disadvantages listed above.

Moreover, the device according to the invention has the advantage that it offers the possibility of influencing the in vitro results to be obtained such that these come as close as possible to the reference values for various test substances derived from a previous panel test.

The skin mimetics according to the invention and the process for adjusting these for various test emulsions are described below by way of example, although the invention is not intended to be limited to these exemplary embodiments. Where ranges, general formulae or compound classes are given below, then these are intended to include hot only the corresponding ranges or groups of compounds which are explicitly mentioned, but also all of the part ranges and part groups of compounds which are obtained by removing individual values (ranges) or compounds. Where documents are cited in the course of the present description, then their content should belong in its entirety to the disclosure of the present invention.

### Cosmetic or Pharmaceutical Compositions to be Applied Topically

Within the context of the invention, cosmetic or pharmaceutical compositions to be applied topically are understood as meaning cosmetic or pharmaceutical formulations, and also individual or several constituents of such formulations. Individual constituents are, for example, emollients, emulsifiers, surfactants, thickeners, viscosity regulators, stabilizers, UV photoprotective filters, antioxidants, hydrotropes and polyols, solids and fillers, film formers, pearlescent additives, deodorant and antiperspirant active ingredients, insect repellents, self-tanning agents, preservatives, conditioners, perfumes, dyes, biogenic active ingredients, care additives, superfatting agents or solvents.

### Polyacrylamide

The polyacrylamide matrix used in the present invention can in principle be any known three-dimensionally crosslinked polyacrylamide matrix. Three-dimensionally crosslinked polyacrylamide matrices are sufficiently known to a biochemical person skilled in the art since they are used, for example, during routine laboratory work in the form of gels for separating protein and DNA mixtures.

Suitable polyacrylamide matrices, which are employed in the present invention, can be formed, for example, by polymerizing acrylamide in an aqueous solution in the presence of small amounts of at least one bifunctional crosslinker. Crosslinkers which can be used are one or more compounds selected from, for example, N,N′-methylenebisacrylamide (MBA), piperazine diacrylate, N,N′-bisacrylylcystamine and N,N′-diallyltartratediamide. Preferably, MBA is used as a crosslinker. Through the copolymerization of acrylamide and MBA, a lattice-like network can be formed in three dimensions in which acrylamide chains with intermediate bonds are formed by the MBA.

The preparation of suitable polyacrylamide matrices is described, for example, in Sambrook et al. Molecular Cloning: A Laboratory Manual, 2nd ed., Cold Spring Harbor Laboratory, 1989.

The composition of the polyacrylamide matrices is usually described by a nomenclature which describes the ratio of acrylamide to crosslinker, such as, for example, bisacrylamide, to water. In this nomenclature, T is the percentage fraction (weight per volume; w/v) of the sum of acrylamide and crosslinker together in aqueous solution and C is the percentage mass fraction (weight per weight; w/w) of crosslinker monomers of the sum of crosslinker monomers and acrylamide monomers. A five (w/v) percent aqueous polyacrylamide matrix in which the mass ratio of MBA monomers to acrylamide monomers corresponds to 1:33 would accordingly have values of T=5% and C=3%.

By varying these values it is possible, as required, to obtain polyacrylamide matrices with different pore sizes. The pore size of the polymer matrix can be reduced by increasing the T value. The pore size can also be adjusted by varying C.

Devices according to the invention preferably have polyacrylamide matrices with a T value from 3 to 15%, preferably from 4 to 12%, more preferably from 4 to 8% and even more preferably of 5%.

The C value of polyacrylamide matrices preferred according to the invention is preferably from 2 to 6%, more preferably from 2 to 4% and even more preferably 3%.

Particularly preferred devices have polyacrylamide matrices with T and C values of T=3 to 15% and C=2 to 6%, preferably of T=4 to 12% and C=2 to 4%, and more preferably of T=5% and C=3%. Rehydrated matrices from GE Healthcare “CleanGel™ for IEF” are ideal.

### Polypeptides

The polypeptides which may be present in the device according to the invention are in principle all polypeptides. The family of the organically chemical compounds “polypeptides” is sufficiently known to a biochemical person skilled in the art as a substance class. The polypeptides are characterized in that individual amino acids are bonded via an amide bond in a defined sequence to a branched or unbranched chain. Examples of synthetic polypeptides are polyornithine and polylysine. One example of a branched, naturally occurring polypeptide is cyanophycin.

Within the context of the present invention, the term “polypeptide” is also intended to be understood as meaning longer amino acid chains (more than 100 amino acids), which are generally referred to as “proteins”. Proteins are divided into different groups; the groups of albumins and globulins are characterized by their abundance and their simple isolation. As a result of this, members of these groups, such as, for example, bovine serum albumin, ovalbumin, alpha- and beta-lactoglobulin are mostly commercially available inexpensively in large amounts.

Preferably, devices according to the invention include, as polypeptides, proteins selected from the family of globulins or albumins. Devices according to the invention preferably include, as polypeptides, bovine serum albumin or beta-lactoglobulin, with beta-lactoglobulin being highly preferred.

Preferred embodiments of the device according to the invention include polyacrylamide matrices with a peptide content from 0.5 to 5, preferably 1 to 4 and more preferably 2 to 3 g, of polypeptide per litre of matrix volume.

pH

It may be advantageous if the polyacrylamide matrices of the present invention have a pH from 4 to 10, preferably 5 to 8 and more preferably a pH of 5.5. The pH can be influenced by incubating the matrices in buffers. To adjust the pH, the polyacrylamide matrices preferably have a suitable buffer system, e.g., tris, PBS or carbonate buffer. A highly preferred buffer that can be used in the present invention is acetate buffer.

Further organic substances, such as, for example, lipids or ceramides, can be added to the polyacrylamide matrices.

The device can have a camera for documenting and/or measuring the spreading using images produced by the camera.

Preferably, the device has a CCD camera, with a CCD size of 0.5″, 1392×1040 effective pixels and a resolution of 12 bit, which is connected to a computer with evaluation software. Preferred evaluation software is “Image J”.

For the exact application of the substance to be investigated, the device can have a syringe. Preferably, the device has a Hamilton syringe. The Hamilton syringe is preferably attached in a height-adjustable clamp.

A preferred device is characterized in that the contrasting required for the automatic evaluation is achieved by light refraction within a drop by illuminating a white cut-out in the size of the substrate within a black surface below the substrate by means of a main light source.

The device according to the invention and/or the polyacrylamide matrix can be obtained by embedding a suitable amount of at least one suitable polypeptide into a polyacrylamide matrix. Before the polymerization process of the acrylamide, the polypeptide can be homogeneously mixed in and thus run through the matrix uniformly. The polypeptide may be covalently bonded to the matrix. The polypeptide can be introduced into the polyacrylamide matrix by incubating the matrix in an aqueous solution containing the polypeptide, or else by rehydrating previously dried polyacrylamide matrices in aqueous solution containing the polypeptide.

Preferably, a suitable polyacrylamide matrix is prepared by the process according to the invention for adapting the inventive device to a series of substances to be investigated which is characterized by the process steps A). determining the parameters C₁ and n of the spreading behavior of the compositions to be investigated in the course of a panel test, B). varying the C and T values of the polyacrylamide matrix, of the polypeptide and/or its concentration and/or the pH value and/or the way in which the polypeptide is introduced into the matrix to give various embodiments and determining the parameters C₁ and n of the spreading behavior of the compositions to be investigated for each embodiment, and C. comparing the parameters of A. and B. and selecting the embodiment of the device with the polyacrylamide matrix which exhibits the greatest correlation of the measurement data.

### Mathematical Kinetics Model for Spreading Behaviour

To evaluate the experimental data, a mathematical model of the spreading kinetics of a drop on a surface was developed.

The formula:

A(t)=C₁*tⁿ

gives the surface area (A) of a spreading drop modulated by the parameters C₁ and n as a function of the time (t).
Logarithming gives

log A=n log t+log C₁

For experimentally determined A and t, C₁ and n are calculated by log-log plotting of the measurement data in Excel (Microsoft Corp.) according to the general straight-line equation

y=mx+b

by means of the axis intercept and the gradient C₁.

The mathematical model reproduced the measured values well.

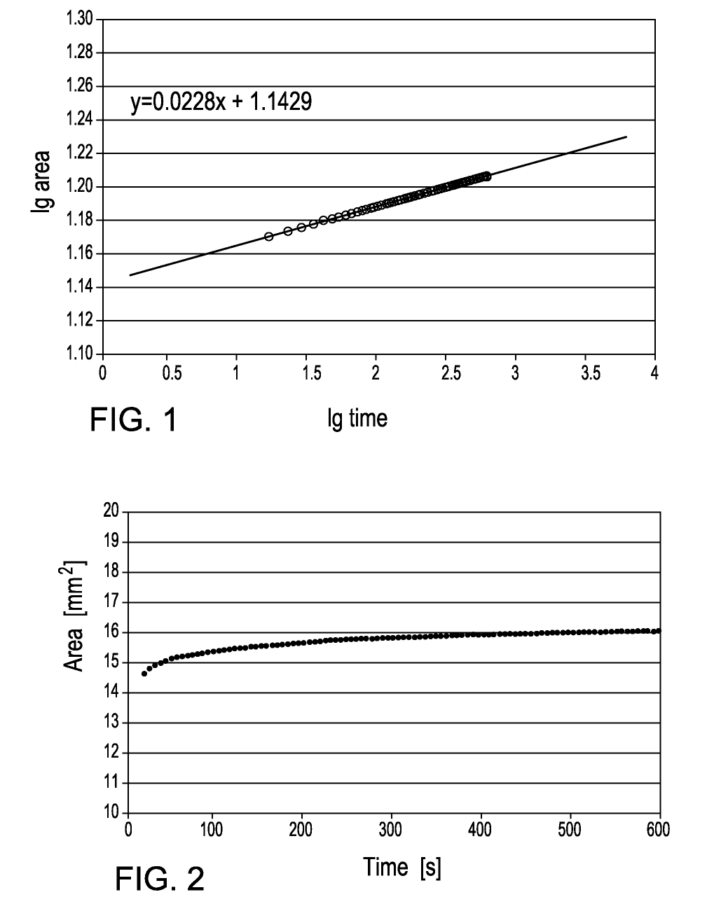

Compare, for example, FIGS. 1 and 2.

In order to optimally adapt the inventive device to different substances X₁ to X_{y} to be measured, the following process is followed: determination of the parameters C₁ and n according to “mathematic kinetics model” of the spreading behavior of substances X₁ to X_{y} in the course of a panel test; varying the C and T values of the polyacrylamide matrix, of the polypeptide and its concentration and the pH (embodiment a1 to an) and determining the parameters C₁ and n for each embodiment a₁ to aₙ for the substances X₁ to X_{y} and comparing the parameters C₁ and n for (X_{1 panel test} to X_{y panel test}) with those ascertained in each case for (X₁ₐ₁ to X_{ya1}) to (X₁ₐₙ to X_{yan}) and subsequently choosing the best suited composition for the device (embodiment aₒₚₜ) through correlation of the measurement data.

### Panel Test

In the panel test, the largest possible number of subjects is preferably used. Preference is given to using more than 10 persons, with more than 15 persons being more preferred. The subjects may be of any sex and from any age group. Preferably, the group of subjects statistically represents the average population of Europe with regard to sex and age.

On the subjects, any skin areas can be used for investigating the spreading behavior. Preference is given to using the inside of the forearm. The section of skin that is employed can be cleaned prior to application of the test substance. Preferably, this area of skin is washed with a 1% strength betaine solution and then with clear water. It may be advantageous to attach a size marker to the area of skin used. Preferably, a circular mark with a diameter of 5 cm is drawn on using stamping ink. A small amount, preferably 10 μl, of the substance to be investigated is applied in the center of the markings. The application takes place preferably with a micropipette. The longitudinal axes of the resulting ellipses are determined at different times. Preferably, a sliding calliper is used for determining this parameter. The determination takes place preferably after 3 and 5 minutes or after 5 and 15 minutes.

### Simulation

For the simulation of spreading phenomena of cosmetic and pharmaceutical formulations using a biomimetic modelling system for human skin, the substance to be investigated is applied to the polyacrylamide matrix in as punctiform a manner as possible. For this purpose, preference is given to using a Hamilton syringe filled with the test substance. This is brought as close as possible to the polyacrylamide matrix, preferably using a height-adjustable clamp and preferably to a distance of 0.6 mm, and a small amount, preferably 10 μl, are applied to the matrix.

After applying a drop of the test substance and, if appropriate, removing the syringe, the spreading behavior can be recorded. Preferably, a camera is used to monitor the changes in the system, preferably using a digital camera system, particularly preferably a NET Foculus 432Sc/B.

The contrasting required for the automatic evaluation can be achieved through light diffraction within the drop by illuminating a white cut-out in the size of the substrate within a black surface below the substrate by means of a main light source.

The area of the drop on the substrate can be determined using the images which have been recorded at different times. The images can be evaluated using software, preferably the program “Image J”.

The process according to the invention can be carried out at any desired temperature and atmospheric humidity; preferably, all of the measurements are carried out in a climatically controlled room, particularly preferably at a temperature of 24.5°±0.5° C. and an atmospheric humidity of 55±5%.

In the examples below, the present invention is described by way of example, without any intention to restrict the invention, the scope of application of which emerges from the entire description and the claims, to the embodiments specified in the examples.

### EXAMPLES

### Microscope Set-Up/Measurement Method

After loading 10 μl of the emollient using a Hamilton syringe, which was mounted into an adjustable clamp, a camera (NET Foculus 432Sc/B) was used to record an image of the drop on the substrate every 6 seconds. The area of the drop on the substrate was determined. For this, the images were evaluated using the program “Image J” in that the program calculated the area within the usually circular edge of the drop as number of pixels. The area was converted to mm² by comparison with an object of known size. For automatic evaluation, it was necessary for the contours of the drop to stand out from the transparent substrate in a contrast-rich manner. For the required light refraction within the drop, a main light source (here a simple energy saving lamp was used at a distance of about 30 cm alongside the substrate) to illuminate a black area (about 20 cm below the substrate) with a white cut-out in the size of the substrate. The light was thus reflected exclusively perpendicularly relative to the substrate so that within the drop, the plane-convex shape did not lead to a parallel shift of the light rays as when passing through the plane substrate, but a modified direction of propagation of the light and thus to the diffraction of light. The drop thus appeared black for the camera. The technical data of the camera are as follows:

| | |
|---|---|
| CCD size | ½″ |
| Effective pixels | 1392 × 1040 |
| Resolution | 12 bit/8 bit (=4096 or 256 grey levels) |
| Optical connection | C-mount |
| Modi | Mono8, Mono16 |
| Digital interface | Firewire (IIDC 1.30) |
| Transfer rates | 100 Mb/s |
| Images/sec | 20 (8 Bit), 10 (12 Bit) |
| Gain | manual, 0 . . . 25 db, Auto Gain |
| Scanning mode | progressive scan |
| Shutter | 1 μs . . . 65 s, manual/automatic |
| Trigger | Software or external trigger, Modi 0~5, 14, |
| | single images or sequences |
| Features | 1 × 2, 2 × 2 binning, flash output |
| Gamma | 1.0 |
| Voltage | DC 8 V . . . 30 V via firewire cable |
| Weight | 110 g |
| Dimensions | 44 mm × 29 mm × 63 mm |

### Preparation of the Gels

The gels (CleanGel IEF) stored at −20° C. were rehydrated in a buffer solution for one hours prior to use. The buffer solution comprised 0.1% 100% strength acetic acid and 0.8% potassium acetate (99%). The buffer was adjusted to a pH of 5.5 by adding 5 molar KOH solution (85%).

If appropriate, protein, such as, for example, BSA, was dissolved in the buffer in the stated concentrations. The buffer solution was poured into a gel pool and a gel section measuring about 1.5×1.5 cm in size was inserted for one hour. After removing the gel, the water was removed from the polyester side using a filter paper and by raising the gel section on the edge on filter paper, dried further. When a drying time of 20 minutes had expired, the measurement was started.

### Series 0

The panel test was carried out as described with three emollients—decyl cocoate (TEGOSOFT DC®), bis-2-ethylhexyl carbonate (TEGOSOFT DEC®, C₁₂-C₁₅-alkyl benzoate (TEGOSOFT TN®), referred to below as A, B and C—and with 0.1% strength mixtures of cetyldimethicones (ABEL WAX 9840®) in the specified emollients—referred to below as A+S, B+S and C+S.

The spreading was compared by averaging the 5-minute values.

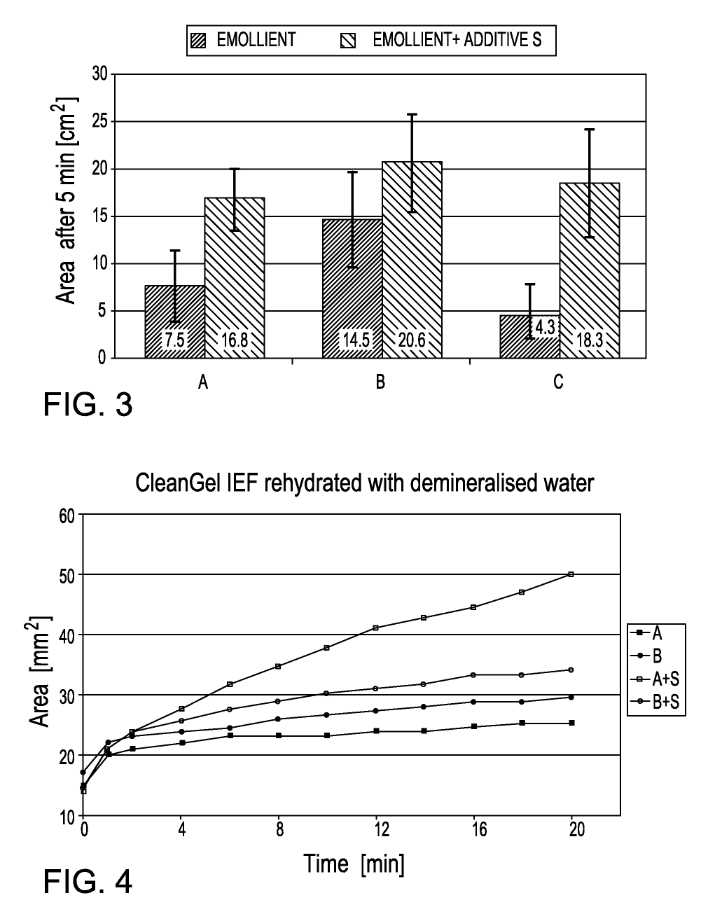

The following results were round for the spreading, as shown in FIG. 3:
For the emollients, the following sequence applies for the spreading: C<A<B.
For the emollient-cetyldimethicone mixtures, the following applies for the spreading: A<A+S, B<B+S and C<C+S. Furthermore, the following sequence applies: A+S≦C+S<B+S.
It is also the case that the spreading of emollient B is the only one in the order of magnitude of the other emollients.

The spreading of the emollients and of the emollient-cetyldimethicone mixtures was carried out as described on CleanGel IEF which had been rehydrated with demineralised water. The following results were found for the spreading of the substances, as shown in FIG. 4:
For the emollients, the following sequence applies for the spreading: A<B.
For the emollient-cetyldimeticone mixtures, the following applies for the spreading: A<A+S and B<B+S. Furthermore, the following sequence applies: B+S<A+S.

Using CleanGel IEF rehydrated in demineralised water it was thus not possible to reproduce the results of the panel test.

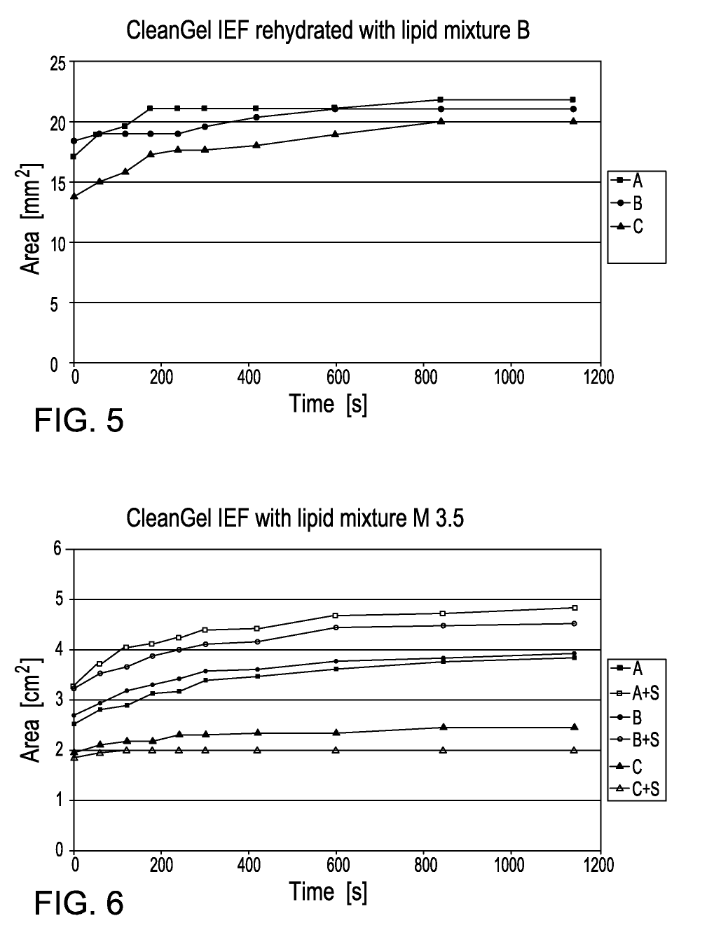

The spreading of the emollients and of the emollient-cetyldimethicone mixtures was carried out as described on CleanGel IEF which had been rehydrated a) with a vegetable oil/water emulsion (1.5% (v/v) sunflower oil, which was incorporated by passing twice through a “French press cell disruption system” from Thermo Electron Corporation at 1000 psi) and b) with a protein/lipid emulsion (UHT milk with a fat content of 3.5% (v/v)). The following results were found for the spreading of the substances, as shown in FIG. 5 and FIG. 6:

a)
For the emollients, the following sequence applies for the spreading: C<B<A

b)
For the emollients, the following sequence applies for the spreading: C<A<B
For the emollient-cetyldimethicone mixtures, the following applies for the spreading: A<A+S and B<B+S and C>C+S. Furthermore, the following sequence applies: C+S<B+S<A+S

Using CleanGel IEF rehydrated in demineralised water, in vegetable oil emulsion and milk, the results of the panel test could therefore not be reproduced.

### Series 1

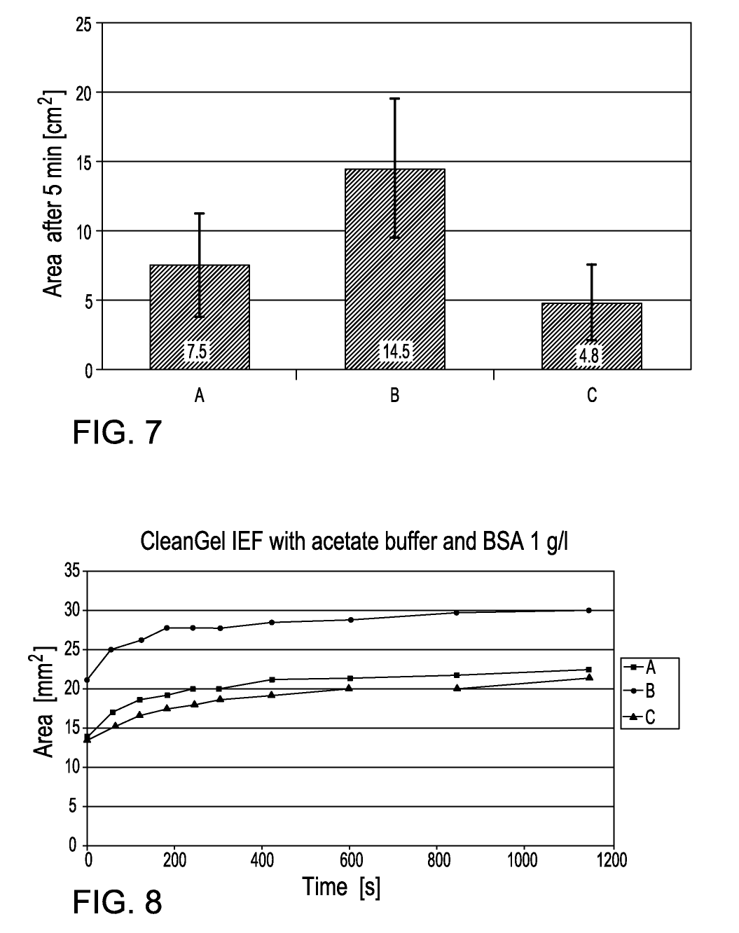

The panel test was carried out as described with three emollients—decyl cocoate (TEGOSOFT DC®), bis-2-ethylhexyl carbonate (TEGOSOFT DEC®), C₁₂-C₁₅-alkyl benzoate (TEGOSOFT TN®), referred to below as A, B and C. As result, the following results were found for the spreading, as shown in FIG. 7:
For the emollients, the following sequence applies for the spreading: C<A<B.

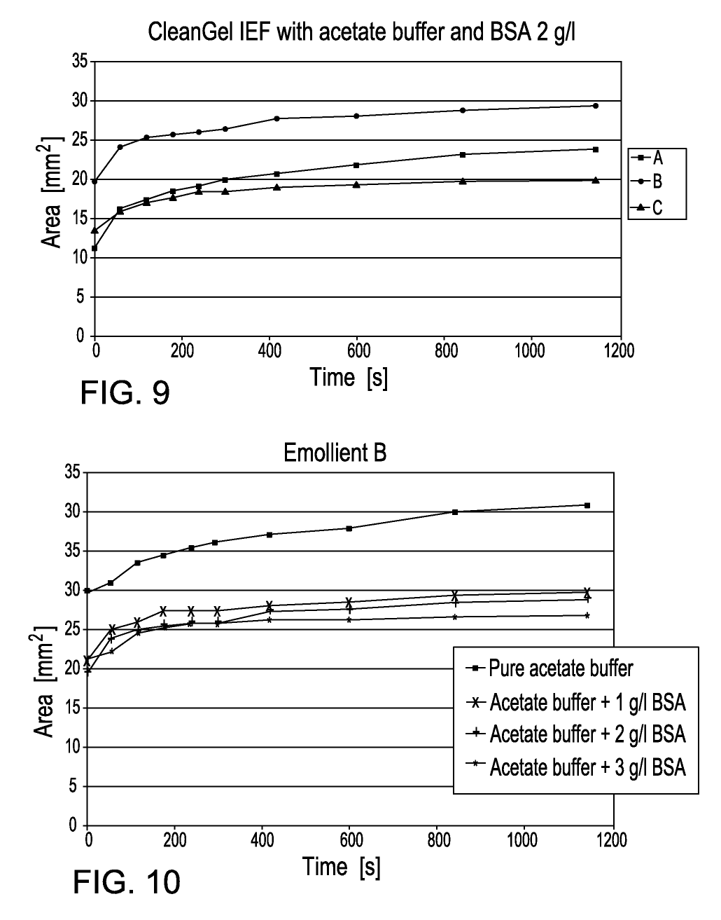

The spreading of the emollients was carried out as described on CleanGel IEF which had been rehydrated with a) 1 mg/ml and b) 2 mg/ml of BSA (albumin fraction V, AppliChem, Article No. A1391.0100, CAS No. 9048-46-8) in completely demineralised water. As shown in FIGS. 8 and 9, the following results were found for the spreading of the substances:
For the emollients, the following sequence applies for the spreading for both BSA concentrations: C<A<B.

Using CleanGel TEF rehydrated in aqueous BSA solution, the results of the panel test for the pure emollients could be reproduced.

The spreadability of the emollients could be influenced by changing the concentration of BSA in the aqueous solutions for the rehydration of CleanGel IEF (FIG. 10).

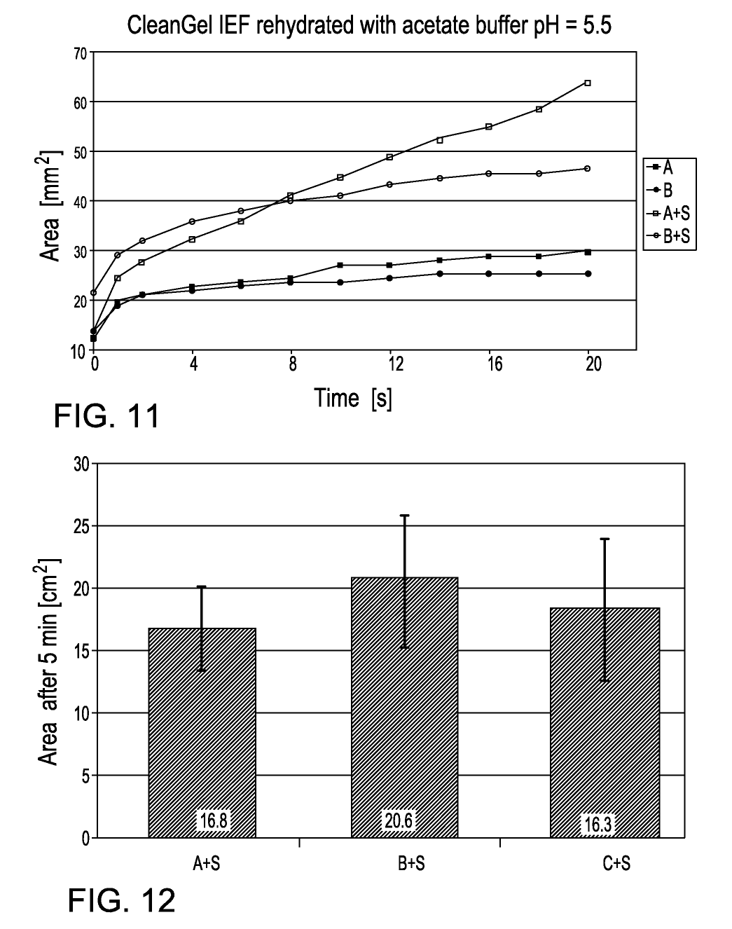

The spreadability of the emollients could furthermore be influenced by adjusting the pH of the solutions for the rehydration of CleanGel IEF (FIGS. 4 and 11).

### Series 2

The panel test was carried out as described with 0.1% strength mixtures of cetyldimethicone (ABIL WAX 9840®) in the three emollients decyl cocoate (TEGOSOFT DC®), bis-2-ethylhexyl carbonate (TEGOSOFT DEC® and C₁₂-C₁₅-alkyl benzoate (TEGOSOFT TN®), referred to below as A+S, B+S and C+S. As result, the following results were found for the spreading, as shown in FIG. 12:
For the emollient-cetyldimethicone mixtures, the following applies for the spreading: A+S≦C+S<B+S.

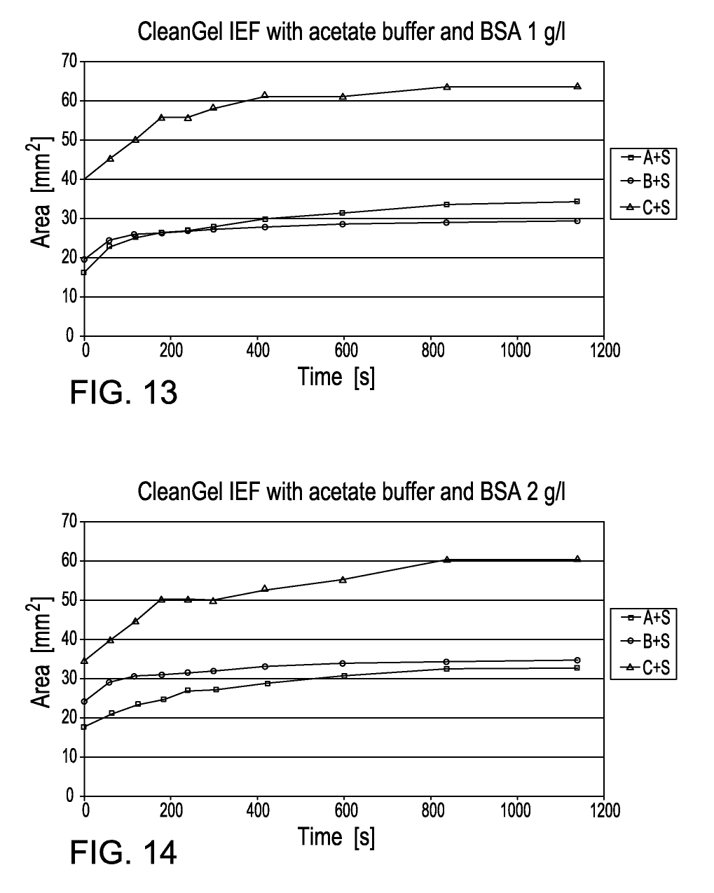

The spreading of the emollient-cetyldimethicone mixtures was carried out as described on CleanGel IEF which had been rehydrated with a) 1 mg/ml and b) 2 mg/ml of BSA*(albumin fraction V, AppliChem, Article No. A1391.0100, CAS No. 9048-46-8) at pH 7.0. As shown in FIGS. 13 and 14, the following results were found for the spreading of the substances:

a)
For the emollient-cetyldimethicone mixtures, the following applies for the spreading: A+S≈B+S<C+S.

b)
For the emollient-cetyldimethicone mixtures, the following applies for the spreading: A+S<B+S<C+S.

Using CleanGel IEF rehydrated in aqueous BSA solution, the results of the panel test for the emollient-cetyldimethicone mixtures could not be reproduced.

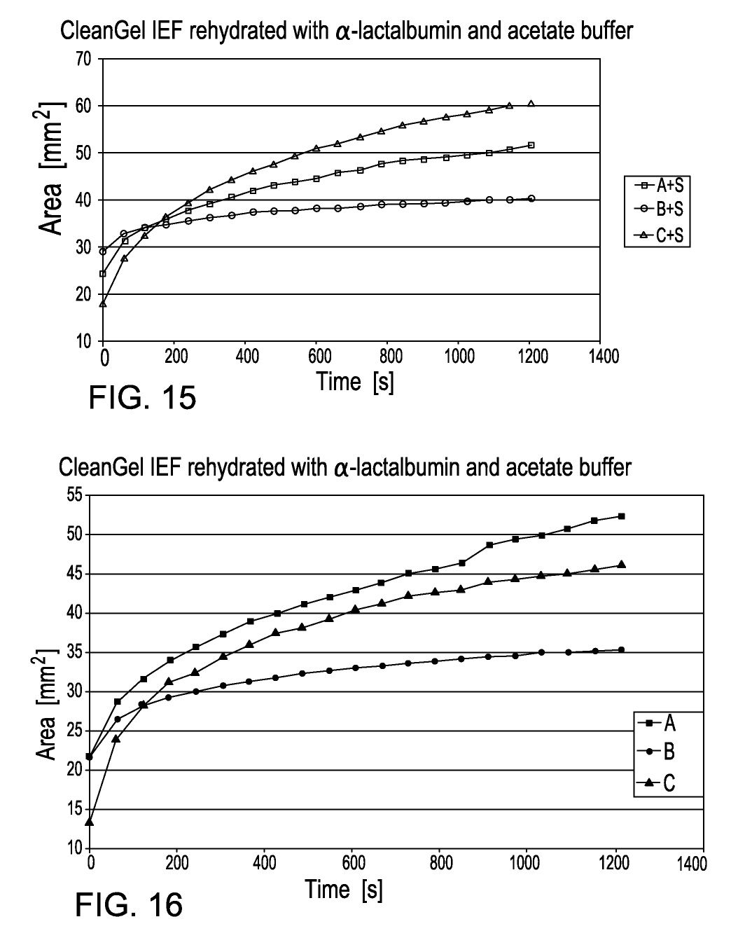

The spreading a) of the emollient-cetyldimethicone mixtures and b) of the pure emollients was carried out as described on CleanGel IEF which had been rehydrated with 150 mg/l of α-lactalbumin (α-lactalbumin from cows' milk from Sigma-Aldrich, type I, ≧85% (PAGE), lyophilized powder, CAS number 9051-29-0) at pH 5.5 (acetate buffer). As shown in FIGS. 15 and 16, the following results were found for the spreading of the substances:

a)
For the emollient-cetyldimethicone mixtures, the following applies for the spreading: C+S<A+S<B+S for spreading times which were shorter than two minutes, and B+S<A+S<C+S for spreading times which were greater than two minutes.

b)
For the pure emollients, the following applies for the spreading: B<C<A.

Using CleanGel IEF rehydrated in aqueous α-lactalbumin solution, the results of the panel test for the emollient-cetyldimethicone mixtures for spreading times of less than two minutes could be partly reproduced, for spreading times greater than two minutes could not be reproduced and for the pure emollient could likewise not be reproduced.

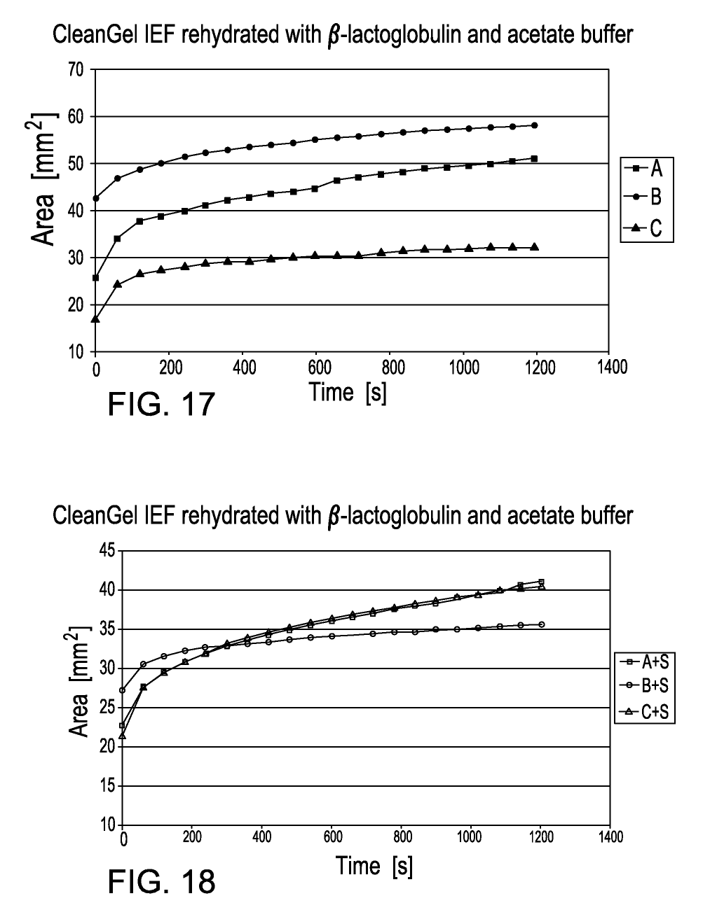

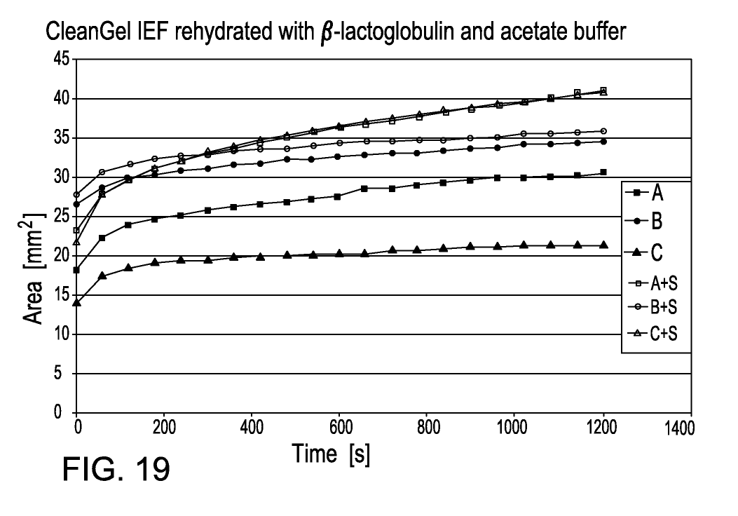

The spreading a) of the pure emollients and b) of the emollient-cetyldimethicone mixtures was carried out as described on CleanGel IEF which had been rehydrated with 150 mg/l of β-lactoglobulin (β-lactoglobulin from cows' milk, Sigma-Aldrich, ˜90% (PAGE), lyophilized powder, CAS number 9045-23-2) at pH 5.5 (acetate buffer). As shown in FIGS. 17 to 19, the following results were found for the spreading of the substances:
For the emollients, the following sequence applies for the spreading: C<A<B.
For the emollient-cetyldimethicone mixtures, the following applies for the spreading: A<A+S, B<B+S and C<C+S. Furthermore, within the first five minutes, the following sequence applies: A+S≦C+S<B+S.
Furthermore, the spreading of emollient B is the only one in the order of magnitude of the other emollients.

Using CleanGel IEF rehydrated in aqueous β-lactoglobulin solution, the results of the panel test for the pure emollients and for the emollient-cetyldimethicone mixtures could thus be reproduced.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. A device comprising a skin substitute for investigating the behavior of cosmetic and/or pharmaceutical compositions to be applied topically, said skin substitute is a three-dimensionally crosslinked polyacrylamide matrix in which water and at least one polypeptide are bonded in said matrix.

2. The device according to claim 1, wherein the polyacrylamide matrix has a T value of T=3 to 15% and a C value of C=2 to 6%.

3. The device according to claim 1, wherein the polyacrylamide matrix has a T value of T=4 to 12% and a C value of C=2 to 4%.

4. The device according to claim 1, wherein the polyacrylamide matrix has a T value of T=5% and a C value of C=3%.

5. The device according to claim 1, wherein the at least one polypeptide is one of albumin and globulin.

6. The device according to claim 1, wherein the at least one polypeptide is bovine serum albumin.

7. The device according to claim 1, wherein the at least one polypeptide is beta-lactoglobulin.

8. The device according to claim 1, further comprising a digital camera connected to a computer with evaluation software.

9. The device according to claim 1, further comprising a syringe that applies a drop of a substance to said skin substitute, said substance is one of a cosmetic product and a pharmaceutical product.

10. The device according to claim 1 wherein said drop is contrasted for automatic evaluation by illuminating a white cut out having a size of the substrate within a black surface below the substrate by means of a main light source.

11. A process for adapting the device according to claim 1 to a series of compositions to be investigated, comprising the steps of.
A. determining parameters C₁ and n of the spreading behavior of compositions to be investigated in the course of a panel test,
B. varying C and T values of the polyacrylamide matrix, of the polypeptide and/or its concentration and/or the pH and/or the way in which the polypeptide is introduced into the matrix to give various embodiments and determining parameters C₁ and n of the spreading behavior of the compositions to be investigated for each embodiment, and
C. comparing the parameters from A and B and selecting an embodiment of the device with the polyacrylamide matrix which exhibits the greatest correlation of the measurement data.
